(19) United States
(12) Patent Application Publication
(10) Pub. No.: US 2026/0201203 A1
(43) Pub. Date: Jul. 16, 2026

(54) COMPOSTABLE POLYMER COMPOSITIONS WITH BARRIER PROPERTIES AND THE METHOD OF MAKING THEREOF

(71) Applicant: Erthos Inc., Mississauga (CA)

(72) Inventor: Nima ZARRINBAKHSH, Mississauga (CA)

(73) Assignee: Erthos Inc., Mississauga (CA)

(21) Appl. No.: 19/447,320

(22) Filed: Jan. 13, 2026

Related U.S. Application Data
(60) Provisional application No. 63/745,106, filed on Jan. 14, 2025.

(51) Int. Cl. C09D 167/03; C08K 3/34; C08K 5/103; C08K 5/11; C08K 5/1539; C08L 67/02; C09D 167/04; D21H 19/28

(52) U.S. Cl. CPC C09D 167/03; C08K 3/346; C08K 5/103; C08K 5/11; C08K 5/1539; C08L 67/02; C09D 167/04; D21H 19/28; C08L 2201/06

(57) ABSTRACT

The invention includes compositions and methods of production of biodegradable polymer resins with high barrier and resistance against water, water vapor, and oxygen. The biodegradable resin compositions of the invention comprise one or more biodegradable thermoplastic polymers, one or more barrier agents, one or more oils, and optionally one or more substrate adhesion agent and other optional additives. The biodegradable resin compositions of the invention are produced using conventional polymer processing techniques such as extrusion and batch compounding and can be used directly as a single or multi-layer barrier or used as a coating on a substrate such as paper for packaging applications. The method of coating of the biodegradable resin compositions of the invention on substrates can be done via conventional melt or solvent based coating techniques.

### CROSS-REFERENCE TO RELATED APPLICATIONS

This application claims the benefit of priority to U.S. Provisional Application No. 63/745,106, filed Jan. 14, 2025, which is incorporated by reference in its entirety.

### FIELD OF INVENTION

The invention encompasses the development of biodegradable thermoplastic resin compositions for applications, such as extruded films and sheets, as well as injection molded parts with high barrier against water vapor and oxygen as well as high resistance to water with great mechanical properties. The invention further encompasses the application of the resin as a barrier layer in single-layer or multi-layer plastic packagings, or as barrier layer coated on a substrate via cast film extrusion, blown film extrusion, co-extrusion, compression molding, co-injection molding, sandwich molding or solvent-based coating techniques for multi-layer packagings.

### BACKGROUND OF THE INVENTION

Non-plastic substrates such as paper are an attractive option for packaging in food, healthcare or cosmetic applications where biobased, recyclability and biodegradability is desired.

Certain packaging lacks the barrier properties required for the targeted application.

Plastic-coated substrates are used instead to deliver the required barrier performance.

Despite enhancing the barrier properties significantly, most plastics traditionally used for coating different substrates such as paper are petroleum-based and/or non-biodegradable, therefore jeopardizing the recyclability and biodegradability of the resulting packaging.

Biobased and/or biodegradable thermoplastic polymers are great options to be used in place of petroleum-based and/or non-biodegradable polymers.

However, biodegradable thermoplastic polymers exhibit limitations in key barrier properties, including oxygen transmission rate (OTR), water vapor transmission rate (WVTR), water absorbency or water resistance, and water contact angle (WCA).

These shortcomings hinder their broader application in packaging, where robust barrier performance is critical for preserving product integrity and extending shelf life.

### SUMMARY OF THE INVENTION

This summary offers a simplified introduction to several concepts, which are further explained in detail below. It does not aim to highlight key or essential features of the claimed subject matter and should not be used to determine its scope.

The biodegradable thermoplastic resin compositions of the invention can be used as flexible, high-barrier films for single and multilayer applications. They can also be used as coatings to improve the barrier properties of a substrate such as paper for packaging applications through various coating techniques including but not limited to melt extrusion, thermoforming, compression molding, co-injection molding, sandwich molding or solution casting.

The resins demonstrate enhanced barrier properties particularly OTR, WVTR, water absorbency and water contact angle without compromising other properties such as compostability, mechanical and thermal properties.

In certain embodiments, the procedures for the production methods of biodegradable thermoplastic resins for melt blending or solution casting in specific weight ratios are provided.

In various embodiments, the biodegradable resin composition comprises about 1 to about 95 % (w/w) of one or more biodegradable thermoplastic polymers; about 1 to about 30 % (w/w) of one or more of barrier agents; about 1 to about 15 % (w/w) of one or more oils; about 0 to about 15 % (w/w) of one or more substrate adhesion agents; about 0 to about 30 % (w/w) of one or more of additives selected from compatibilizers, biomass, processing aids, chain extenders, initiators, peroxides, impact modifiers and pigments;

### DETAILED DESCRIPTION OF THE INVENTION

To facilitate an understanding of the invention, it will be described more comprehensively herein below. However, the invention may be embodied in different forms and is not limited to the embodiments set forth herein. Rather, these embodiments are provided for the purpose of making the disclosure of the invention more thorough and comprehensive.

Unless otherwise defined, all technical and scientific terms used herein have the same meaning as those commonly understood by a person skilled in the art to which the present invention belongs. Terms used in the specification of the present invention are only for the purpose of describing specific embodiments and are not intended to limit the present invention.

### DEFINITIONS

As used herein, “additive” could refer to material used to enhance a targeted property or function of material and/or composition, which could be in any form such as solid, liquid, powder, fiber, or crystal.

The prefix “bio” as used herein refers to a material that has been derived from a renewable biological resource.

The term “biobased” or “bio-based” refers to compositions that are derived from plant matter instead of being made from petroleum or natural gas. Because these are plant-based, there is a tendency to assume that the additive must be biodegradable. However, this is not the case for all plant-based compositions. The bio-based compositions of the invention can be designed to biodegrade in less than 6 months.

The term “biodegradable” refers to compositions of the invention that can biodegrade within 12 months in a compost environment in a non-toxic, environmentally compatible manner with no heavy metal nor PTFE content, and remaining soil-safe (i.e., lack of eco-toxins). The hydrophobic compositions of the invention biodegrade within 12 months. Compostable materials are biodegradable, but not every biodegradable material is compostable. The hydrophobic compositions of the invention are well known to be biodegradable. As used herein, “biodegradable” compositions are engineered to biodegrade in compost, soil, or water.

The term “bioplastics” or “biopolymer” is used to refer to plastics that are bio-based, biodegradable, or fit both criteria. Bio-based plastics of the invention are fully or partly made from renewable feedstock derived from biomass. Commonly used raw materials to produce the renewable feedstock for plastic production includes, but is not limited to, corn starch, corn stalks, sugarcane stems, cellulose, and various oils and fats from renewable sources.

The term “compostable” compositions refer to biodegradation into soil conditioning material (i.e., compost). In order for a plastic to be labeled as commercially “compostable” it should be broken down by biological treatment at an industrial composting facility in 180 days or less. Composting utilizes microorganisms, agitation, heat, and humidity to yield carbon dioxide, water, inorganic compounds, and biomass that is similar in characteristic to the rest of the finished compost product. Decomposition of the composition should occur at a rate similar to the other elements of the material being composted (e.g., within 6 months) and leave no toxic residue that would adversely impact the ability of the finished compost to support plant growth. ASTM Standards D6400 and D6868 outline the specifications that must be met in order to label a plastic as “industrial compostable”.

The term “disintegration” refers to a plastic product that leaves no more than 10 % of its original dry weight after twelve weeks (84 days) in a controlled thermophilic composting test and sieved through a 2.0-mm mesh.

The term “polymers” refers to polymers of the invention that are obtained, for example, by aliphatic diols, aliphatic dicarboxylic acids, and aromatic dicarboxylic acids/esters. The term polymers also includes aliphatic-aromatic polymers. The biodegradable thermoplastic polymers of the current invention include but are not limited to: polylactic acid (PLA) or poly(lactic acid) (PLA); polycaprolactone (PCL); poly(butylene succinate) (PBS) or polybutylene succinate (PBS); polyglycolic acid (PGA) or poly(glycolic acid) (PGA); poly(butylene succinate adipate) (PBSA), polybutylene succinate adipate (PBSA), poly(butylene succinate-co-adipate) (PBSA), polybutylene succinate-co-adipate (PBSA), poly(butylene succinate-co-butylene adipate) (PBSA) or polybutylene succinate-co-butylene adipate (PBSA); poly(butylene succinate terephthalate) (PBST), polybutylene succinate terephthalate (PBST), poly(butylene succinate-co-terephthalate) (PBST), polybutylene succinate-co-terephthalate (PBST), poly(butylene succinate-co-butylene terephthalate) (PBST) or polybutylene succinate-co-butylene terephthalate (PBST); poly(butylene adipate terephthalate) (PBAT), polybutylene adipate terephthalate (PBAT), poly(butylene adipate-co-terephthalate) (PBAT), polybutylene adipate-co-terephthalate (PBAT), poly(butylene adipate-co-butylene terephthalate) (PBAT) or polybutylene adipate-co-butylene terephthalate (PBAT); and polyhydroxyalkanoates (PHAs).

The term polyhydroxyalkanoates (PHAs) refers to a family of bio-based thermoplastic polymers synthesized by various microorganisms, particularly through bacterial fermentation. The PHA family encompasses over 150 different monomers, allowing for the production of materials with a wide range of properties. Notably, these plastics are biodegradable and include, but are not limited to, poly-3-hydroxybutyrate (PHB), polyhydroxybutyrate-co-hydroxyvalerate (PHBV), poly-4-hydroxybutyrate (P4HB), polyhydroxybutyrate-co-hydroxyhexanoate (PHBH), polyhydroxyvalerate (PHV), polyhydroxyhexanoate (PHH), polyhydroxyoctanoate (PHO), polyhydroxydecanoate (PHD), and polyhydroxydodecanoate (PHDD).

The terms “resin” and “blend” as used herein interchangeably, refer to a homogeneous mixture of two or more different polymers and elastomers along with other ingredients.

As used herein, “wt. %”, “parts by mass (w/w)” or “parts by mass % (w/w)” refer to the percentage weight of an ingredient with respect to the total weight of a composition.

### Composition of The Biodegradable Thermoplastic Resin

In various embodiments, the invention encompasses biodegradable thermoplastic polymers. The biodegradable thermoplastic polymers of the invention comprise biodegradable thermoplastic polyesters including, but not limited to, at least one or more of polylactic acid (PLA), polyglycolic acid (PGA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs), other biodegradable polymers, and a combination thereof. The biodegradable thermoplastic polymers of the invention can also comprise thermoplastic naturally occurring polymers including but not limited to thermoplastic starch, alginates, soy protein, casein, pea protein, corn zein, and a combination thereof.

The parts by mass (w/w) of the biodegradable thermoplastic polymer in the biodegradable resin composition are about 1 to 95 wt. %. In various embodiments, the parts by mass (w/w) of biodegradable thermoplastic polymers in the resin are about 1, 2, 3, 5, 8, 10, 20, 30, 40, 50, 60, 70, 80, 90 and 95 wt. %.

The embodiment compositions may include, but are not limited to, any of the following polymer combinations:

In certain embodiments, the biodegradable thermoplastic polymers include polylactic acid and polycaprolactone.

In certain embodiments, the biodegradable thermoplastic polymers include polylactic acid and polybutylene succinate.

In certain embodiments, the biodegradable thermoplastic polymers include polylactic acid and polybutylene succinate adipate.

In certain embodiments, the biodegradable thermoplastic polymers include polylactic acid and polybutylene succinate terephthalate.

In certain embodiments, the biodegradable thermoplastic polymers include polylactic acid and polybutylene adipate terephthalate.

In certain embodiments, the biodegradable thermoplastic polymers include polylactic acid and polyhydroxyalkanoates.

In certain embodiments, the biodegradable thermoplastic polymers include polycaprolactone and polybutylene succinate.

In certain embodiments, the biodegradable thermoplastic polymers include polycaprolactone and polybutylene succinate adipate.

In certain embodiments, the biodegradable thermoplastic polymers include polycaprolactone and polybutylene succinate terephthalate.

In certain embodiments, the biodegradable thermoplastic polymers include polycaprolactone and polybutylene adipate terephthalate.

In certain embodiments, the biodegradable thermoplastic polymers include polycaprolactone and polyhydroxyalkanoates.

In certain embodiments, the biodegradable thermoplastic polymers include polybutylene succinate and polybutylene succinate adipate.

In certain embodiments, the biodegradable thermoplastic polymers include polybutylene succinate and polybutylene succinate terephthalate.

In certain embodiments, the biodegradable thermoplastic polymers include polybutylene succinate and polybutylene adipate terephthalate.

In certain embodiments, the biodegradable thermoplastic polymers include polybutylene succinate and polyhydroxyalkanoates.

In certain embodiments, the biodegradable thermoplastic polymers include polybutylene succinate adipate and polybutylene succinate terephthalate.

In certain embodiments, the biodegradable thermoplastic polymers include polybutylene succinate adipate and polybutylene adipate terephthalate.

In certain embodiments, the biodegradable thermoplastic polymers include polybutylene succinate adipate and polyhydroxyalkanoates.

In certain embodiments, the biodegradable thermoplastic polymers include polybutylene succinate terephthalate and polybutylene adipate terephthalate.

In certain embodiments, the biodegradable thermoplastic polymers include polybutylene succinate terephthalate and polyhydroxyalkanoates.

The abovementioned embodiments are not limited to binary combinations of biodegradable thermoplastic polymers, but could encompass combinations of three or more biodegradable thermoplastic polymers.

In one embodiment, the biodegradable blend composition further includes, in parts by mass (w/w) of about 1 to about 30 % of one or more barrier agents. In various embodiments, the amount of the barrier agents is about 1, 2, 3, 4, 5, 6, 7, 8, 9, 10, 12.5, 15, 17.5, 20, 22.5, 25, 27.5, and 30 wt. %.

In certain embodiments, the barrier agents include but are not limited to, wollastonite, mica, micron and nano clays, non-ionic clays such as serpentinite, illite, kaolinite, pyrophyllite, vermiculite, chlorite and talc, cationic clays such as vermiculites, smectites (montmorillonite, nontronite and beidellite, and trioctahedral smectites, such as saponite), and swelling micas, anionic clays such as hydrotalcites, layered double hydroxides, calcium carbonate, glass fiber, aluminum silicate, silicon dioxide, zirconium oxide, sepiolite, gypsum, and other minerals and a combination thereof, all in modified or unmodified form.

In various embodiments, the aspect ratio of the barrier agent is modified through physical and/or chemical techniques.

In various embodiments, the barrier agent is treated through physical and/or chemical techniques to modify its surface functional groups, its physical form, or for other purposes.

In one embodiment, the biodegradable resin composition further includes in parts by mass (w/w) of about 1 to about 15 of at least one oil. In various embodiments, the amount of the oil is about 0.01, 0.05, 0.1, 0.2, 0.3, 0.4, 0.5, 0.6, 0.7, 0.8, 0.9, 1, 2, 3, 4, 5, 6, 7, 8, 9, 10, 11, 11.5, 12, 12.5, 13,13.5, 14, 14.5 and 15 wt. %.

In various embodiments, the oils include but are not limited to, plant-based oils obtained from sources such as vegetables, nuts, grains, seeds, etc. Examples of such oils include, but are not limited to, corn oil, soybean oil, and glycerol. These plant-based oils can be used either in their virgin or modified form (e.g., through epoxidation, carboxylation, hydroxylation, and amidation). Modified plant-based oils such as chemically modified vegetable oil, epoxidized vegetable oil, epoxidized soybean oil, epoxidized linseed oil, and a range of citrate oils (e.g., acetyl tributyl citrate (ATBC), triethyl citrate (TEC), acetyl triethyl citrate (ATEC), tributyl citrate (TBC)), as well as isosorbide-type oils, natural waxes, glycol, sugar alcohols (e.g. xylitol, sorbitol, lactitol, mannitol, erythritol, maltitol), isosorbide diester, and fatty acid methyl esters (FAME) are also encompassed.

In one embodiment, the biodegradable blend composition further includes, in parts by mass (w/w) of about 0 to about 15 % of one or more substrate adhesion agents which encompasses both short and long-chain hydrocarbons with functional groups such as, but not limited to, epoxides, hydroxyls, anhydrides, silanes and citrates.

In one embodiment, the substrate adhesion agent encompasses titanate, aluminate, γ-aminopropyltriethoxysilane, γ-(2,3)epoxy (propoxy)propyltrimethoxysilane, γ-methacryloxypropyltrimethoxysilane, maleic anhydride grafted biodegradable polymers, hydrolyzed biodegradable polymers, peroxides and a combination thereof.

Yet in another embodiment, the substrate adhesion agent encompasses at least one or more bio-based organic acids including, but not limited to lactic acid, formic acid, stearic acid, tannic acid, malic acid, citric acid, aspartic acid, ascorbic acid, acetic acid, tartaric acid, and a combination thereof.

In various embodiments, the amount of the substrate adhesion agents is about 0, 0.01, 0.05, 0.1, 0.2, 0.3, 0.4, 0.5. 0.6, 0.7, 0.8, 0.9, 1, 2, 3, 4, 5, 6, 7, 8, 9, 10, 11, 12, 13, 14, and 15 wt. %.

In one embodiment, the biodegradable blend composition further includes, in parts by mass (w/w) of about 0 to about 30 % of one or more additives including but not limited to compatibilizers, biomass, processing aids, chain extenders, initiators, peroxides, and pigments;

In various embodiments, the amount of the additives is about 0, 0.01, 0.05, 0.1, 0.2, 0.3, 0.4, 0.5. 0.6, 0.7, 0.8, 0.9, 1, 2, 3, 4, 5, 6, 7, 8, 9, 10, 12.5, 15, 17.5, 20, 22.5, 25, 27.5, and 30 wt. %.

In certain embodiments, the biomass includes, but not limited to, distillers'grains, vinasse, vinegar residues, cellulose nanocrystals, wood fiber, virgin starch, modified starch including thermoplastic starch, agricultural cellulosic matter from straw, stalk, shive, hurd, bast, leaf, seed, fruit, and perennial grass, all in a non-continuous non-woven form including chopped pieces, particulates, dust or flour.

In certain embodiments, a substrate coated with the final composition of the biodegradable resin in the amount of 1-150 g/m2 (grams per square meter substrate) exhibits an improvement in water vapor transmission rate (WVTR) of up to 99.5% compared to the substrate.

In certain embodiments, a substrate coated with the final composition of the biodegradable resin in the amount of 1-150 g/m2 (grams per square meter substrate) exhibits an improvement in oxygen transmission rate (OTR) of up to 99.5% compared to the substrate.

In certain embodiments, the final composition of the biodegradable resin exhibits a water contact angle of more than 70°.

In certain embodiments, a substrate coated with the final composition of the biodegradable resin in the amount of 1-150 g/m2 exhibits a water absorption (Cobb 60) of less than 0.5 g/m2 .

In certain embodiments, a substrate coated with the final composition of the biodegradable resin in the amount of 1-150 g/m2 exhibits a lamination strength of more than 3N/15 mm after lamination on paper.

In certain embodiments, a substrate coated with the final composition of the biodegradable resin in the amount of 1-150 g/m2 is heat sealable at temperatures less than 150° C. under a pressure of at most 110 psi for 1 second.

In certain embodiments, a substrate coated with the final composition of the biodegradable resin in the amount of 1-150 g/m2 exhibits a heat sealing strength of more than 4N/15 mm.

In certain embodiments, the composition exhibits a water vapor transmission rate (WVTR) of less than 2000 g·μm/m2/day at 38° C. and 90 % relative humidity.

In certain embodiments, the composition exhibits a water vapor transmission rate (WVTR) of less than 200 g·μm/m2/day at 38° C. and 90 % relative humidity.

In certain embodiments, the composition exhibits an oxygen transmission rate (OTR) of less than 5000cc·μm/m2/day at 23° C. and 50 % relative humidity.

In certain embodiments, the composition exhibits an oxygen transmission rate (OTR) of less than 500 cc·μm/m2/day at 23° C. and 50 % relative humidity.

In certain embodiments, the composition exhibits a tensile strength of more than 10 MPa.

In certain embodiments, the composition exhibits a tensile strength of more than 20 MPa.

In certain embodiments, the composition exhibits a tensile strength of more than 30 MPa.

In certain embodiments, the composition exhibits a tensile strength of more than 40 MPa.

In certain embodiments, the composition exhibits an elongation at break of more than 100 %.

In certain embodiments, the composition exhibits an elongation at break of more than 200 %.

In certain embodiments, the composition exhibits an elongation at break of more than 300 %.

In certain embodiments, the composition exhibits an elongation at break of more than 400 %.

In certain embodiments, the composition exhibits an elongation at break of more than 500 %.

In certain embodiments, the composition exhibits an elongation at break of more than 600 %.

In certain embodiments, the composition exhibits 10%, 20%, 30%, 40%. 50%. 60%, 70%. 80%, or 90% disintegration completion within about 180 to about 365 days at ambient temperature.

In certain embodiments, the composition exhibits 10%, 20%, 30%, 40%. 50%. 60%, 70%. 80%, or 90% disintegration completion within about 180 to about 365 days in soil at ambient temperature.

In certain embodiments, the composition exhibits more than 90 % disintegration in less than 30, 35, 40, 45, 50, 55, 60, 65, 70, 75, 80, 81, 82, 83, 84, 85, 86, 87, 88, 89, or 90 days under thermophilic temperature conditions.

In certain embodiments, the composition exhibits more than 90 % biodegradation in less than 30, 40, 50, 60, 70, 80, 90, 100, 110, 120, 130, 140, 150, 160, 170, 175, or 180 days under thermophilic temperature conditions.

In certain embodiments, the composition exhibits more than 90 % biodegradation in less than 30, 40, 50, 60, 70, 80, 90, 100, 110, 120, 130, 140, 150, 160, 170, 180, 200, 225, 250, 275, 300, 325, 340, 345, 350, or 356 days under mesophilic (ambient) temperature conditions.

In certain embodiments, the final composition of the biodegradable resin exhibits 90 % disintegration within 120 days under mesophilic (home composting) conditions and 90 % disintegration within 120 days under thermophilic (industrial composting) conditions.

In certain embodiments, the final composition of the biodegradable resin is 100 % compostable under home and/or industrial compostability conditions.

### Method of Production of The Biodegradable Resin Composition and Its Coating on a Substrate

The aforementioned ingredients may be processed together in various scenarios. In one embodiment, all ingredients are premixed and melt-processed together.

In another embodiment, the biodegradable thermoplastic polymer(s) is melted first, and then the rest of the ingredients are added to the system.

In another embodiment, the biodegradable thermoplastic polymer(s) is plasticized first and then the rest of the ingredients are added to the system.

In another embodiment, the biodegradable thermoplastic polymer(s) is melted first along with the barrier agent(s), and then the other ingredients are added to the system before the addition of thermoplastic starch.

In yet another embodiment, the biodegradable thermoplastic polymer(s) is melted first, and then the other additives are added to the system before the barrier agent(s) is added.

The order of introducing the ingredients to the system is not limited to these embodiments and may include any other possible embodiments and combinations.

In one embodiment, the blending of the aforementioned ingredients may be achieved using mixing and melt-compounding equipment with adjustable and controllable temperatures, such as a single or twin screw extruder, or a batch mixer.

In a batch mixer, the processing temperature profile may range from 50 to 250° C., and the processing time may be between 1 to 60 minutes.

Alternatively, in embodiments where single or twin screw extrusion is employed, the temperature profile may range from 50 to 250° C., and the screw speed may range from 20 to 500 rpm.

It should be noted that the processing conditions provided herein are not limiting and may vary based on other conditions such as ingredient amounts and ratios and the type of processing equipment.

The resulting product may be pelletized and subsequently formed into desired shapes and parts using conventional forming techniques including, but not limited to, injection molding, compression molding, thermoforming, film blowing, or cast film extrusion for single or multilayer packaging products. The forming temperature is typically within the range used in the melt-processing and compounding of the resins and ingredients.

Alternatively, the resulting product may be pelletized and subsequently coated on a substrate using conventional coating techniques including, but not limited to, compression molding, thermoforming, extrusion coating, co-extrusion, cast film extrusion, blown film extrusion, co-injection molding, or sandwich molding for multilayer packaging products.

Optionally, the adhesion of the coating made from the biodegradable resin composition onto the substrate can be improved or adjusted using a tie layer including but not limited to adhesives and primers such as aqueous emulsions of polyester and polyurethane polymers assisted or not assisted with isocyanurate-type oligomers, unmodified and modified sodium alginate, unmodified and modified starch, unmodified and modified proteins, unmodified and modified sugars, or a combination thereof wherein the tie layer is coated on the substrate in the amount of 1-50 g/m2 (grams per square meter substrate) using conventional adhesive and primer coating techniques.

The aforementioned ingredients can alternatively be processed using a solvent-based method. The solvent required to dissolve the polymers can include but is not limited to, Dimethyl Carbonate, Cyrene, Dimethyl Isosorbide, Dimethyl Sulfoxide, γ-Butyrolactone, Anisole, γ-Valerolactone, Propylene Carbonate, Methyl Lactate, Diethyl Carbonate, Chloroform, Dichloromethane, Tetrahydrofuran, Dimethylformamide, Hexafluoroisopropanol, and 1,4-Dioxane.

The ingredients could be introduced to the system in any possible embodiments and combinations.

In various embodiments, the ingredients will be mixed and dissolved at a temperature higher than room temperature over a period of time depending on the nature of the solvent. The weight ratio of the composite ingredients to the solvent is between 1:2 and 1:100.

The solution then can be turned into polymeric films using techniques including but not limited to, solution casting, spin coating, electrospinning, spray drying, and solvent evaporation.

Alternatively, the solution can be coated on a substrate using solution based coating techniques including, but not limited to, solution casting, spin coating, wet lamination, dispersion coating, and spray coating.

The substrate includes, but is not limited to, a cellulose-based substrate, such as paper, paperboard, molded paper, cardboard, or a polymer-based substrate, such as biobased, petroleum-based, biodegradable, and compostable polymer films and sheets.

### General Embodiments of the Invention

The present invention will now be explained in greater detail by means of the following examples.

Example 1: A biodegradable resin composition was produced via a benchtop micro-compounder twin screw extruder. A premix of 252 g PBAT, 18 g PGA, 28 g PLA, and 18 g ATBC was prepared in a bowl by mixing the ingredients thoroughly and manually. The resin was produced in batches of 14 g. In each cycle, about 12.6 g of the premix was fed into the micro-compounder along with 1.4 g of layered double hydroxide and all ingredients were compounded at 230° C. and 400 rm for 2 min. At the end of the cycle the micro-compounder die was opened to let a melt strand of the compounded resin be extruded and collected. Once cooled, all strands were pelletized and further compression molded at 230° C. into sheets of about 260 μm to about 280 μm for barrier and water contact angle testing. The resin pellets were also coated on kraft paper using the same compression molding technique for lamination strength and Cobb 60 water absorbency measurements. All testing was carried out complying with ASTM and TAPPI standard conditions.

The test results showed a WVTR of about 130 g/m2/day at about 40° C. and about 90% relative humidity; a Cobb 60 value of about 1 g/m2 with about 140 g/m2 of coating on the kraft paper; a water contact angle of about 65°; and a maximum lamination strength of about 1.3N/15 mm.

Example 2: A biodegradable resin composition was produced via a benchtop micro-compounder twin screw extruder. A premix of 215 g PBAT, 45 g PGA, 30 g mica and 11 g isosorbide diester was prepared in a bowl by mixing the ingredients thoroughly and manually. The resin was produced in batches where in each cycle, about 14 g of the premix was fed into the micro-compounder and all ingredients were compounded at 230° C. and 400 rm for 2 min. At the end of the cycle the micro-compounder die was opened to let a melt strand of the compounded resin be extruded and collected. Once cooled, all strands were pelletized and further compression molded at 180° C. into sheets of about 450 μm for barrier and water contact angle testing. The resin pellets were also coated on kraft paper using the same compression molding technique for lamination strength and Cobb 60 water absorbency measurements. All testing was carried out complying with ASTM and TAPPI standard conditions.

The test results showed a WVTR of about 58 g/m2/day at about 40° C. and about 90% relative humidity; a Cobb 60 value of about 0.7 g/m2 with about 150 g/m2 of coating on the kraft paper; a water contact angle of about 44°; and a maximum lamination strength of about 5.2N/15 mm.

Example 3: First, 0.48 g layered double hydroxide, 0.3 g ATBC, and 0.09 g other additives including equal amounts of a chain extender, a peroxide and a coupling agent were homogenized in 54 g solvent, dimethyl carbonate (DMC), using a high speed homogenizer at 5000 rpm for 20 min. Then, 4.65 g PBAT and 0.48 g PLA were added to the DMC solution and stirred on a hot plate at 60-75° C. using a magnetic stirrer for 4 hours until dissolution was completed. During the dissolution, the beaker was covered to avoid evaporation of solvents. The solution was then stirred on the hot plate without cover for another 30 min. The solution was cast uniformly on a level surface on PTFE and kraft paper using a doctor blade automatic coating machine and then dried overnight at a temperature of 60° C. in a convection oven. The films on PTFE were about 30 um and peeled off for barrier and water contact angle testing and the paper coated samples were used for lamination strength and Cobb 60 water absorbency measurements.

The test results showed a WVTR of about 710 g/m2/day at about 40° C. and about 70% relative humidity; a Cobb 60 value of about 0.3 g/m2 with about 46 g/m2 of coating on the kraft paper; a water contact angle of about 62°; and a maximum lamination strength of about 1.4N/15 mm.

Examples 4 and 5: Two biodegradable resin compositions were produced via a benchtop micro-compounder twin screw extruder with the following compositions:

Example 4: 212.5 g PBAT, 37.5 g montmorillonite

Example 5: 205 g PBAT, 37.5 g montmorillonite, 7.5 g substrate adhesion agent

In both Examples 4 and 5, a premix of all ingredients was prepared in a bowl by mixing the ingredients thoroughly and manually. The resin was produced in batches where in each cycle, about 13 g of the premix was fed into the micro-compounder and all ingredients were compounded at 180° C. and 400 rm for 1.5 min. At the end of the cycle the micro-compounder die was opened to let a melt strand of the compounded resin be extruded and collected. Once cooled, all strands were pelletized and further compression molded at 180° C. into sheets of about 420 μm to about 470 μm for barrier testing. The resin pellets were also coated on kraft paper using the same compression molding technique for lamination strength and Cobb 60 water absorbency measurements. All testing was carried out complying with ASTM and TAPPI standard conditions.

The test results showed a WVTR of about 44 g/m2/day for Example 4 and about 53 g/m2/day for Example 5 both measured at about 38° C. and about 90% relative humidity; a Cobb 60 value of about 0.2 g/m2 for both Examples with about 140 g/m2 and about 130 g/m2 of coating on the kraft paper for Example 4 and Example 5, respectively; and a maximum lamination strength of about 5.3N/15 mm and 6.7N/15 mm for Example 4 and Example 5, respectively.

Example 6: A biodegradable resin composition was produced via a twin screw extruder. A premix of 4000 g PBAT, 500 g PHA, 350 g talc, and 150 g maleic anhydride grafted biodegradable polyesters was prepared in a 20-L pail by mixing the ingredients thoroughly and manually. The premix was continuously fed in the twin screw extruder, preheated to a temperature profile of 130° C.-160° C., and compounded at a screw speed of 100 rpm. The compound was then extruded out into strands at a throughput rate of about 25 kg/hr. The strands were then cooled on a fan-cooling conveyor and chopped into small pellets using a pelletizer. The pellets were then fed into a cast film extruder, preheated to a temperature profile of 140° C.-175° C., to be melted at a screw speed of less than 30 rpm and extruded into thin films of 5-250 μm by adjusting the rotational speeds of chiller and winding rolls. The thin films were then used for WVTR measurements. Additionally, thin films of less than 10 μm were extrusion coated onto individual sheets of paper of 60 μm to be used for WVTR, lamination strength, water contact angle and Cobb 60 water absorbency measurements. All measurements were carried out complying with ASTM and TAPPI standard conditions.

The test results for the standalone films showed a WVTR of about 89 g/m2/day and 743 g/m2/day for films of about 220 μm and 7 μm, respectively, tested at about 40° C. and about 90% relative humidity. The test results for the extrusion coated paper samples showed a WVTR of about 179 g/m2/day tested at about 23° C. and about 90% relative humidity, a Cobb 60 value of about 0.2 g/m 2 with about 10 g/m2 of coating on the paper, a water contact angle of about 50°, and a maximum lamination strength of about 0.22N/15 mm.

Examples 7 and 8: Two biodegradable resin compositions were produced via a twin screw extruder with the following compositions:

Example 7:4650 g PBAT, 350 g talc.

Example 8:4500 g PBAT, 350 g talc, 150 g chemically modified vegetable oil.

In both Examples 7 and 8, a premix of all ingredients was prepared in a 20-L pail by mixing the ingredients thoroughly and manually. The premix was continuously fed in the twin screw extruder, preheated to a temperature profile of 130° C.-160° C., and compounded at a screw speed of 100 rpm. The compound was then extruded out into strands at a throughput rate of about 25 kg/hr. The strands were then cooled on a fan-cooling conveyor and chopped into small pellets using a pelletizer. The pellets were then fed into a cast film extruder, preheated to a temperature profile of 140° C.-175° C., to be melted at a screw speed of less than 30 rpm and extruded into thin films of 210 um by adjusting the rotational speeds of chiller and winding rolls. The thin films were then used for WVTR and water contact angle measurements. All measurements were carried out complying with ASTM standard conditions.

The test results showed a WVTR of about 117 g/m2/day for Example 7 and about 108 g/m2/day for Example 8 both measured at about 40° C. and about 90% relative humidity; a water contact angle of about 50° for Example 7 and 58° for Example 8.

While the present invention has been described with reference to a number of preferred embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiments disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A biodegradable resin composition comprising:
i. about 1 to about 95 % (w/w) of one or more biodegradable thermoplastic polymers;
ii. about 1 to about 30 % (w/w) of one or more of barrier agents;
iii. about 1 to about 15 % (w/w) of one or more oils;
iv. about 0 to about 15 % (w/w) of one or more substrate adhesion agents;
v. about 0 to about 30 % (w/w) of one or more of additives selected from compatibilizers, biomass, processing aids, chain extenders, initiators, peroxides, and pigments;

2. The biodegradable resin composition of claim 1, wherein the biodegradable thermoplastic polymer is one or more of biodegradable thermoplastic polyesters selected from the group consisting of polylactic acid (PLA), polyglycolic acid (PGA), polycaprolactone (PCL), polybutylene succinate (PBS), polybutylene succinate adipate (PBSA), polybutylene succinate terephthalate (PBST), polybutylene adipate-co-terephthalate (PBAT), polyhydroxyalkanoates (PHAs);
and thermoplastics naturally occurring polymers selected from the group consisting of thermoplastic starch, alginates, soy protein, casein, pea protein, corn zein; and a combination thereof.

3. The biodegradable resin composition of claim 1, wherein the barrier agent is selected from the group consisting of wollastonite, mica, micron and nano clays, non-ionic clays, serpentinite, illite, kaolinite, pyrophyllite, vermiculite, chlorite, and talc, cationic clays, vermiculites, smectites (montmorillonite, nontronite and beidellite, and trioctahedral smectites, such as saponite), swelling micas, anionic clays, hydrotalcites, layered double hydroxides, unmodified or modified hydrotalcite, calcium carbonate, glass fiber, aluminum silicate, silicon dioxide, zirconium oxide, sepiolite, gypsum, and a combination thereof, all in modified or unmodified form.

4. The biodegradable resin composition of claim 1, wherein the oil of the blend is a plant-based oil selected from the group consisting of vegetables, nuts, grains, seeds, or combinations thereof, wherein the oils comprise corn oil, soybean oil, chemically modified vegetable oil, epoxidized vegetable oil, epoxidized soybean oil, epoxidized linseed oil, fatty acid methyl esters, citrate oils, acetyl tributyl citrate (ATBC), triethyl citrate (TEC), acetyl triethyl citrate (ATEC), tributyl citrate (TBC), isosorbide-type oils, natural waxes, glycol, sugar alcohols, glycerol, xylitol, sorbitol, lactitol, mannitol, erythritol, maltitol, isosorbide diester, fatty acid methyl esters (FAME), and combinations thereof.

5. The biodegradable resin composition of claim 1, wherein the substrate adhesion agent is selected from the group comprising of titanate, aluminate, γ-aminopropyltriethoxysilane, γ-(2,3)epoxy (propoxy)propyltrimethoxysilane, γ-methacryloxypropyltrimethoxysilane; maleic anhydride grafted biodegradable polymers; hydrolyzed biodegradable polymers; peroxides; organic acids selected from formic acid, stearic acid, tannic acid, malic acid, citric acid, aspartic acid, ascorbic acid, acetic acid, tartaric acid; short or long-chain hydrocarbons with functional groups selected from epoxides, hydroxyls, anhydrides, silanes and citrates; and a combination thereof.

6. The biodegradable resin composition of claim 1, wherein the biomass is selected from distillers'grains, vinasse, vinegar residues, cellulose nanocrystals, wood fiber, virgin starch, modified starch including thermoplastic starch, agricultural cellulosic matter from straw, stalk, shive, hurd, bast, leaf, seed, fruit, and perennial grass, all in a non-continuous non-woven form including chopped pieces, particulates, dust or flour.

7. The biodegradable blend composition of claim 1, wherein the bio-based carbon content of the composition is up to 100 %.

8. The biodegradable resin composition of claim 1, wherein the composition exhibits a 90% biodegradation completion within about 180 to about 365 days in soil at ambient temperature.

9. The biodegradable resin composition of claim 1, wherein the composition exhibits a water vapor transmission rate (WVTR) of less than 2000 g·μm/m2 /day at 38° C. and 90 % relative humidity.

10. The biodegradable resin composition of claim 1, wherein the composition exhibits an oxygen transmission rate (OTR) of less than 5000 cc·μm/m2 /day at 23° C. and 50 % relative humidity.

11. The biodegradable resin composition of claim 1, wherein the composition exhibits a tensile strength of more than 20 MPa.

12. The biodegradable resin composition of claim 1, wherein the composition exhibits an elongation at break of more than 100 %.

13. A method of producing the biodegradable blend composition of claim 1, in which the ingredients are mixed and melt-compounded together in a polymer processing equipment or apparatus selected from the group consisting of a batch mixer, a twin screw extruder or single screw extruder, at elevated temperatures for a time period of several seconds to several minutes.

14. A method of producing the biodegradable blend composition of claim 1, in which the ingredients are mixed via solvent based techniques.

15. A barrier layer comprising:
i. a cellulose-based substrate, selected from the group consisting of paper, paperboard, molded paper, molded fiber, cardboard, corrugated box or a polymer-based substrate, comprising polymers selected from the group consisting of biobased, petroleum-based, biodegradable, and compostable polymer films and sheets,
ii. optionally, a primer selected from the group consisting of aqueous emulsions of polyester and polyurethane polymers assisted or not assisted with isocyanurate-type oligomers, unmodified and modified sodium alginate, unmodified and modified starch, unmodified and modified proteins, unmodified and modified sugars, or a combination thereof wherein the primer is coated on the substrate in the amount of 1-50 g/m2 (grams per square meter substrate) using conventional primer coating processing techniques,
iii. a biodegradable resin composition of claim 1
wherein the biodegradable resin composition is coated on the substrate or on the primer-coated substrate in the amount of 1-150 g/m2 (grams per square meter substrate) using conventional coating processing techniques.

16. A barrier layer of claim 15, wherein the layer shows up to 99.5 % reduction, in water vapor transmission rate, oxygen transmission rate, and water absorbency in comparison to the substrate.

17. A barrier layer of claim 15, wherein the layer shows more than 30 % increase in water contact angle in comparison to the substrate.

18. A barrier layer of claim 15, wherein the lamination strength of the biodegradable resin composition coated on the substrate is more than 1N/15 mm.

19. A barrier layer of claim 15, wherein the layer is heat sealable at temperatures less than 150° C. under a pressure of at most 110 psi for a maximum of 1.5 second.

20. A barrier layer of claim 15, wherein the layer is heat sealable with a sealing strength of more than 4N/15 mm.
